(19) United States
(12) Patent Application Publication
(10) Pub. No.: US 2026/0255123 A1
(43) Pub. Date: Aug. 27, 2026

(54) SPLIT BINAURAL RENDERING

(71) Applicants: Dolby Laboratories Licensing Corporation, San Francisco, CA (US); DOLBY INTERNATIONAL AB, Dublin (IE)

(72) Inventors: Stefan BRUHN, Sollentuna (SE); Rishabh TYAGI, Sydney (AU)

(73) Assignees: Dolby Laboratories Licensing Corporation, San Francisco, CA (US); DOLBY INTERNATIONAL AB, Dublin (IE)

(21) Appl. No.: 19/160,301

(22) PCT Filed: Feb. 27, 2024
(86) PCT No.: PCT/US24/17570

§ 371 Date: Aug. 27, 2025

Related U.S. Application Data
(60) Provisional application No. 63/448,830, filed on Feb. 28, 2023.
(60) Provisional application No. 63/558,596, filed on Feb. 27, 2024.

(51) Int. Cl. H04S 7/00; G10L 19/008; G10L 19/032

(52) U.S. Cl. CPC H04S 7/304; G10L 19/008; G10L 19/032; H04S 2400/11

(57) ABSTRACT

The present disclosure describes techniques for low-complexity split rendering based on a limited number of pre-renditions, thereby significantly reducing the required number of computations on the pre-rendering side, as well as the amount of transmitted metadata. The present disclosure further describes low complexity solutions for post-renderer corrections around one, two or three rotation axes, e.g., for deviations of yaw, pitch and roll.

### CROSS-REFERENCE TO RELATED APPLICATIONS

This application is the U.S. National stage entry of Internation Patent Application No. PCT/US2024/017570 filed Feb. 27, 2024, which claims priority to U.S. Provisional Application No. 63/448,830 filed Feb. 28, 2023 and U.S. Provisional Application No. 63/558,596 filed Feb. 27, 2024, the contents of which are herein incorporated by reference in their entirety.

### TECHNICAL FIELD OF THE INVENTION

The present invention relates generally to audio processing, and more specifically to audio rendering (e.g., binaural rendering) performed on two separate devices (“split rendering”).

### BACKGROUND

Unless otherwise indicated herein, the materials described in this section are not prior art to the claims in this application and are not admitted as prior art by inclusion in this section.

Immersive audio is an essential media component of extended reality (XR) applications, which includes augmented reality (AR), mixed reality (MR) and virtual reality (VR). To enhance the user experience, immersive audio may support adjusting the presented immersive audio/visual scene in response to motion of the user. For example, it may be desirable to track a user's head position and head movement during audio rendering and to adjust the audio accordingly. Thus, an immersive audio experience may process head movements using models with three degrees of freedom (3DoF) or six degrees of freedom (6DoF).

Various immersive audio services, e.g., immersive voice and audio services (IVAS), may be used to render high quality audio renditions at the XR device that include awareness of pose information, which may include metadata for head positions with relative or absolute movements of the user. However, making such adjustments according to pose information may require significant computational processing capabilities to achieve a high-quality immersive audio experience.

The computational complexity requirements for immersive audio may be problematic for small form factor devices such as AR glasses. To make them as practical and user-friendly as possible, such AR glasses may avoid using powerful processors and heavy batteries, which may otherwise result in bulky, more expensive, and heavy weight user-worn devices that consume more power and generate a significant amount of heat. Consequently, to enable reasonable form factor low power operation with low latency, such AR devices tend to have processors with reduced complexity and constrained numerical operations.

The present disclosure recognizes the above noted problems and explores potential solutions. One potential solution is to reduce audio rendering requirements at the end-device (e.g., the AR device operated by the user) with a split-rendering topology that leverages processing from some other entity of the mobile/wireless network (e.g., a network based device) to which the end-device is connected or tethered (e.g., via a network or cloud-based connection). For example, a powerful network entity such as mobile user equipment (e.g., UE, a device used by an end-user, a portable multi-function device, a gaming console, a cloud-based resource, etc.) may be connected to the end-device to assist in split-rendering of immersive audio. Pose information based on the user movement may be gathered at the end-device and transmitted to the network entity. The end-device may then receive the already rendered audio from the network entity; where the high complexity calculations such as processing 3DoF/6DoF pose information (e.g., head-tracking metadata) may be performed by the rendering entity (e.g., network entity). One problem with the described split-rendering topology is the latency for transmissions between end-device and network entity may be on the order of 100 ms; which means the network entity may be relying on outdated pose/head-tracking information. Because of this delay, the rendered audio from the network entity may not match the current head pose/head position of the user at the end-device. If the motion-to-sound latency is too large, the end user will experience a perceivable loss of quality in the immersive experience.

U.S. Appl. No. U.S. Ser. No. 18/864,497 discloses a novel approach to interactive headtracking. The described approach generates multiple binaural representations (pre-renditions) corresponding to various head poses at the main device or pre-renderer and computes metadata which can be used along with a reference binaural representation to reconstruct binaural output corresponding to any given pose at the post-renderer. The reference binaural representation and the metadata are sent to a post-rendering device. Based on the reference binaural representation and metadata, and on a difference between a reference pose and a detected current head pose of the user, the post-renderer determines binaural audio corresponding to the current head pose.

U.S. Pat. No. 12,604,152 describes a system relying on a binaural rendering for a reference pose P′ obtained upstream from the post-renderer device, and a number of N pre-renditions for ‘probing’ poses P_{1-N} which are close to reference pose P′.

### SUMMARY

In some applications, complexity constraints at the pre-renderer device and metadata bit rate limitations on the transmission interface between the pre- and post-renderer devices may limit the number of pre-renditions (or binaural representations) to be computed at the pre-renderer device and also may limit the amount of metadata to be transmitted to the post renderer for pose correction. Hence, it may be desired to carefully choose the pre-rendition head poses at the pre-renderer such that pose correction to any head pose at the post-renderer can be achieved with a limited number of pre-renditions at the pre-render and a limited amount of metadata transmission.

One cause of numerical complexity at the pre-renderer device is the required number of pre-renditions. A typical case contemplated for split renderer metadata enabling yaw correction may employ one reference binaural representation and two binaural pre-renditions (N=2), where the two probing poses are P′+X and P′−X′ and wherein X and X′ are angular deviations from P′ around a rotational axis.

It is an object of the present invention to address the described issues, and to enable efficient split rendering with a reduced number of pre-renditions, and consequently a smaller amount of associated metadata.

The present disclosure describes a low-complexity split rendering technique based on a limited number of pre-renditions, thereby significantly reducing the required number of computations on the pre-rendering side, as well as reducing the amount of transmitted metadata. The present disclosure further describes low complexity solutions for post-renderer corrections around one, two or three rotation axes, e.g., for deviations of yaw, pitch and roll.

This and other objects are achieved by various aspects of the present invention including those defined by the independent claims.

According to a first aspect, this and other objects are achieved by a method of rendering audio (in a main device) to enable split rendering techniques with pose correction around multiple rotational axes (in a lightweight device), the method comprising obtaining an immersive audio content, obtaining a reference pose, rendering the immersive audio content into a first number of binaural pre-renditions, wherein the binaural pre-renditions correspond to a set of probing poses, wherein the set of probing poses include poses equal to the reference pose (P′) and/or poses that deviate from the reference pose by rotation around at least one of the rotational axes, calculating a second number of approximate binaural representations based on the binaural pre-renditions, wherein the approximate binaural representations correspond to a set of virtual probing poses, wherein the virtual probing poses deviate from the probing poses by rotation around at least one of the rotational axes, determining a reference binaural representation based on one or more of the binaural pre-renditions and the approximate binaural representations, computing reconstruction metadata enabling reconstruction of the binaural pre-renditions and the approximate binaural representations from the reference binaural representation, encoding the reconstruction metadata and the reference binaural representation in an output bitstream, and outputting the output bitstream.

According to a second aspect, this and other objects are achieved by a method of rendering audio (in a main device) to enable split rendering with pose correction around yaw axis and pitch axis (in a lightweight device), the method comprising obtaining an immersive audio content, obtaining a reference pose, rendering the immersive audio content into a reference binaural representation corresponding to a reference pose, rendering the immersive audio content into one or more binaural pre-renditions, wherein the binaural pre-renditions correspond to one or more probing poses deviating from the reference pose by rotation deviate from the reference pose by rotation around both yaw and pitch axes, computing, for each probing pose, yaw metadata representing a deviation around the yaw axis, and pitch metadata representing deviation around the pitch axis, encoding the reference binaural representation, the yaw metadata and the pitch metadata in an output bitstream, and outputting the output bitstream

According to a third aspect, this and other objects are achieved by a method of rendering audio in a main device to enable split rendering with pose correction around at least one rotational axis (in a lightweight processing device), the method comprising obtaining an immersive audio content, receiving head pose information associated with a user of a lightweight processing device, determining, based on the head pose information, a reference pose, rendering the immersive audio content into a reference binaural representation corresponding to a reference pose, rendering the immersive audio content into one or more binaural pre-renditions, the binaural pre-renditions corresponding to one or more probing poses deviating from the reference pose around the rotational axis, computing reconstruction metadata which enables reconstruction of the binaural pre-renditions from the reference binaural representation, the reconstruction metadata including, for each time-frequency tile, a transformation matrix, computing enhanced metadata by multiplying, each transformation matrix for a specific probing pose with an additional gain matrix (G), the additional gain matrix having the form:

$${G}_{ps} = [ \begin{matrix}{g}_{l , ps} & 0 \\ 0 & {g}_{r , ps}\end{matrix} ] ,$$

$${g}_{l , ps} = sqrt ( \frac{{R}_{y , ps , ps} ( 1 , 1 )}{{R}_{\hat{y} , ps , ps} ( 1 , 1 )} ) ,$$

$${g}_{r , ps} = sqrt ( \frac{{R}_{y , ps , ps} ( 2 , 2 )}{{R}_{\hat{y} , ps , ps} ( 2 , 2 )} ) ,$$

where R_{y,ps,ps} represents a 2×2 covariance matrix of the binaural pre-rendition for the specific probing pose Pₛ, and R_{ŷ,ps,ps} represents a 2×2 covariance matrix of a reconstructed binaural pre-rendition for the specific probing pose Pₛ, encoding the reference binaural representation and the enhanced metadata in an output bitstream, and outputting the output bitstream

According to a fourth aspect, this and other objects are achieved by a method of rendering audio (in a main device) to enable split rendering with pose correction around multiple rotational axes (in a lightweight device), the method comprising obtaining an immersive audio content, receiving head pose information associated with a user of a lightweight processing device, determining, based on the head pose information, a reference pose and at least one of a head pose rotation axis and a head pose rate of rotation, rendering the immersive audio content into a reference binaural representation corresponding to the reference pose, rendering the immersive audio content into a set of binaural pre-renditions, wherein the binaural pre-renditions correspond to a set of probing poses rotated with respect to the reference pose, wherein the probing poses are selected based on the head pose information, computing reconstruction metadata to enable reconstruction of the binaural pre-renditions from the reference binaural representation, encoding the reference binaural representation and the reconstruction metadata in an output bitstream, and outputting the output bitstream.

According to a fifth aspect, this and other objects are achieved by a method of audio processing with pose correction around multiple rotational axes, the method comprising receiving a bitstream from a main device, decoding the bitstream to obtain a reference binaural representation and first reconstruction metadata associated with a set of probing poses representing deviation from a reference pose by rotation around the multiple rotational axes, detecting a current head-pose, for each of the rotational axes, selecting a probing pose closest to the detected pose along the rotation axis, determining axis-specific reconstruction metadata based on the first metadata associated with the selected probing pose and a difference between the reference pose and the current head pose along the rotational axis, and determining a binaural output corresponding to the current head pose based on the reference binaural representation and the axis-specific reconstruction metadata for each rotational axis.

According to a sixth aspect, various objects are achieved by a main processing device, comprising a decoder configured to decode a first bitstream to obtain decoded immersive audio content, a renderer configured to obtain a reference pose, render the immersive audio content into a reference binaural representation based on the reference pose, and render the immersive audio content into a number of binaural pre-renditions, wherein the binaural pre-renditions correspond to a set of probing poses associated with a reference pose, wherein the set of probing poses include poses that deviate from the reference pose by rotation about at least one of the rotational axes, a metadata generator configured to compute reconstruction metadata to enable reconstruction of the binaural pre-renditions from the reference binaural representation, an encoder configured to encode the reference binaural representation and the reconstruction metadata into an output bitstream, and an interface configured to output the output bitstream.

According to a seventh aspect, various objects are achieved by a lightweight processing device comprising a decoder configured to decode a bitstream to obtain a reference binaural representation and first reconstruction metadata associated with a set of probing poses representing deviation from a reference pose by rotation around multiple rotational axes, a head-tracker configured to detect a current head-pose, a binaural reconstruction block configured to, for each of the rotational axes, select a probing pose closest to the detected pose along the rotation axis, and determine axis-specific reconstruction metadata based on the first metadata associated with the selected probing pose and a difference between the reference pose and the current head pose along the rotational axis, and determine a binaural output corresponding to the current head pose based on the reference binaural representation, and the axis-specific reconstruction metadata.

### BRIEF DESCRIPTION OF THE DRAWINGS

The present invention will be described in more detail with reference to the appended drawings.

FIG. 1 shows a user with smartphone and a set of headphones.

FIG. 2 is a diagram illustrating a head pose and rotation around the three axis yaw, pitch and roll.

FIG. 3 is a schematic block diagram showing split rendering in a main processing device and a lightweight processing device.

FIG. 4 is a flow chart illustrating processing in a main processing device, in accordance with embodiments of a first aspect of the invention.

FIG. 5 is a flow chart illustrating processing in a main processing device, in accordance with embodiments of a second aspect of the invention.

FIG. 6 is a flow chart illustrating processing in a lightweight processing device, in accordance with embodiments of a further aspect of the invention.

FIG. 7 is a flow chart illustrating processing in a main processing device, in accordance with embodiments of a yet further aspect of the invention.

FIG. 8 is a flow chart illustrating processing in a main processing device, in accordance with embodiments of a still further aspect of the invention.

FIG. 9 illustrates a schematic block diagram of an example device or architecture that may be used to implement embodiments of the invention.

### DETAILED DESCRIPTION

In the following detailed description, reference is made to the accompanied drawings, which form a part hereof, and which is shown by way of illustration, specific example configurations of which the concepts can be practiced. These configurations are described in sufficient detail to enable those skilled in the art to practice the techniques disclosed herein, and it is to be understood that other configurations can be utilized, and other changes may be made, without departing from the spirit or scope of the presented concepts. The following detailed description is, therefore, not to be taken in a limiting sense, and the scope of the presented concepts is defined only by the appended claims.

Embodiments of the invention disclosed herein assume compatibility and consistency with usage of an immersive audio codec such as IVAS in an XR application. In particular, the inventive concepts described in detail below are applicable to systems, devices, architectures, methods, and techniques where main decoding and pre-rendering are performed by a main device (UE) with high resources such a powerful computational processing (or processor) resources with significant power or battery capabilities (e.g., an edge or other network node/server of an 5G system, a high performance mobile device, etc.) and final decoding and post-rendering are performed by a different device with lower resources relative to the main device (e.g., a lightweight device, a wearable device, AR glasses, head-mounted display, heads-up-display, etc.).

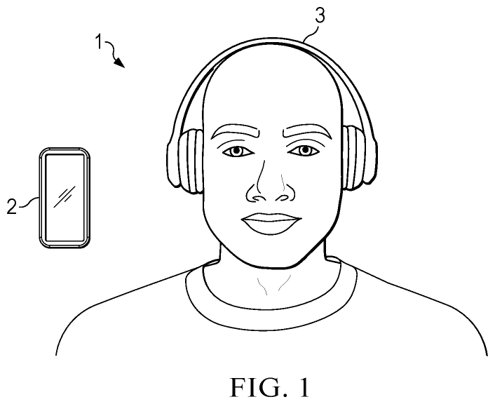

FIG. 1 shows schematically a user 1 having a smartphone 2 and wearing a headset 3. The smartphone could in the context of the present invention serve as the main, pre-rendering device, while the headset could serve as the lightweight, user-held, post-rendering device. It is the post rendering device that has the most recent information about the users head pose P.

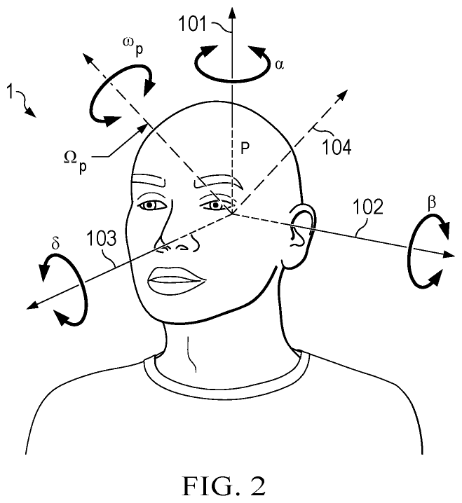

With reference to FIG. 2, a user head pose P is in the present context defined by three degrees of freedom, namely rotation α around the yaw axis 101, rotation β around the pitch axis 102, and rotation γ around the roll axis 103. Of course, the head pose will also be associated with a position in the room, defined by three additional degrees of freedom, spatial coordinates x, y, z. However, spatial translation will not be relevant for the purposes of the present disclosure.

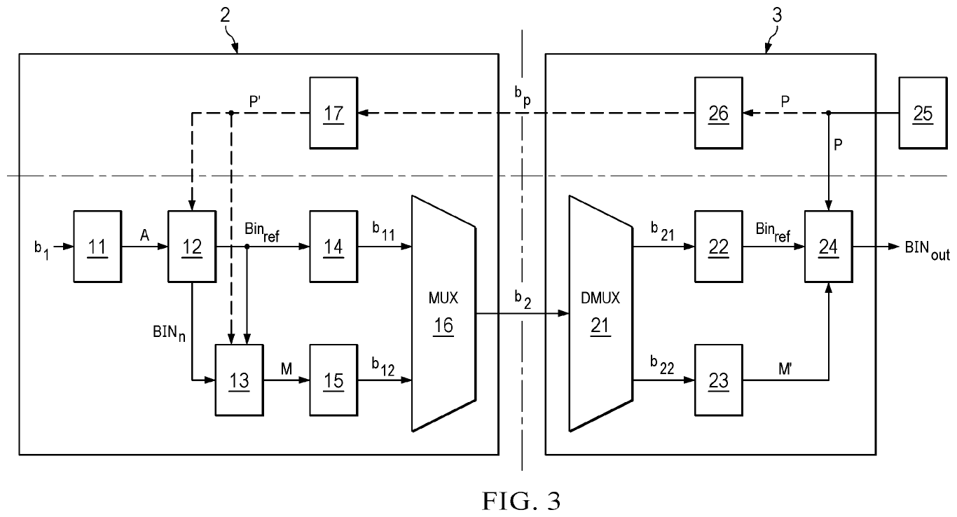

FIG. 3 shows an example of some of the functional blocks that may be implemented in the main device 2 and lightweight device 3 in an example split rendering system.

Here, the main device, or pre-rendering device, 2 includes a decoder 11, a binaural renderer 12, a metadata generator 13, a first encoder 14, a second encoder 15, and a multiplexer 16. The main device 2 may also include a pose decoder 17.

The decoder 11, e.g., an IVAS decoder, is configured to receive and decode a bitstream b₁, and decode an immersive audio content A. The binaural renderer 12 is configured to receive (or obtain) the immersive audio content A and a reference pose P′, and responsively provide a reference binaural representation (rendition) Bin_{ref}, associated with the reference pose P′. The reference pose may be an assumed head pose, or be determined based on head pose information received from the lightweight device 3 via pose decoder 17. The binaural renderer 12 is further configured to responsively render N (N>0) binaural representations (pre-renditions) Binₙ corresponding to a set of probing poses Pₙ associated with the reference pose P′.

The metadata generator 13 is configured to receive the reference binaural representation Bin_{ref} and pre-renditions Binₙ, and responsively generate reconstruction metadata M to enable reconstruction of the pre-renditions from the reference binaural representation. Optionally, the reference pose P′ may be received by metadata generator 13, and responsively encoded in the reconstruction metadata M.

Pose decoder 17 is an optional block that is not required for all implementations. When pose decoder 17 is present, pose decoder 17 is configured to receive head pose information from the lightweight device 3 via bitstream bp, and responsively generate the reference pose P′.

The first encoder 14 is configured to receive the reference binaural representation Bin_{ref}, and responsively encode the reference binaural representation Bin_{ref} as encoded bitstream b₁₁. The second encoder 15 is configured to receive reconstruction metadata M, and responsively encode the reconstruction metadata (and optionally pose information) as encoded bitstream b₁₂. The multiplexer 16 is configured to receive the encoded bitstreams b₁₁ and b₁₂ from the outputs of the two encoders 14 and 15, and responsively combine the encoded bitstreams b₁₁ and b₁₂ into a bitstream b₂. The main device may also include an interface to output the bitstream b₂, whereby the bitstream may be subsequently transmitted or otherwise made available to another device that is external to the main device 2, here the lightweight device 3.

In some embodiments, the encoder 15 is further configured to encode pose information into bitstream b₁₂, where the encoded pose information is indicative of the reference pose P′ and/or the probing poses Pₙ.

The lightweight device, or post-renderer device, 3 here includes a demultiplexer 21, a first decoder 22, a second decoder 23, a binaural reconstruction block 24 and a head-tracker 25. Optionally, the lightweight device 3 also includes a pose information encoder 26.

The demultiplexer 21 is configured to receive bitstream b₂ from the main device 2 and responsively separate the received bitstream b₂ into two encoded bitstreams b₂₁ and b₂₂. The decoder 22 is configured to receive encoded bitstream b₂₁, and responsively decode bitstream b₂₁ into a reference binaural signal Bin_{ref}. The decoder 23 is configured to receive encoded bitstream b₂₂, and responsively decode bitstream b₂₂ into metadata M′ (and, if present, information about the reference pose P′ and/or the probing poses Pₙ). The binaural reconstruction block 24 is configured to receive a current user head pose P detected by the head tracker 25, and responsively determine a binaural output based on the reference binaural signal Bin_{ref}, and the metadata M′, and the current head pose P in relation to the reference pose P′.

As noted, the reference pose P′ and/or the probing poses Pₙ may be included in the bitstream b₂₂ received from the main device 2. This is especially useful when the reference pose is based on pose information received by the main device 2 from the lightweight device 3. However, in some implementations, the reference pose P′ is an assumed pose and thus the lightweight device is already aware of pose information P′. For example, the reference pose may be a “straight ahead” pose, e.g., a pose looking straight at a display device.

In a similar manner, information about the probing poses may be received in the bitstream, but may alternatively be predefined and known by the lightweight device. For example, the probing poses may be pre-defined deviations from the reference pose.

The encoder 26 is an optional block that is not required in all implementations. If encoder 26 is present, encoder 26 is configured to receive pose information P from the head-tracker 25, and responsively encode the pose information in a bitstream bp, which is sent to the main device 2.

In an example implementation, a heavy weight device 2 uses a pose P′ to generate a reference binaural signal Bin_{p′} and metadata (MD) such that the light weight post renderer can do the pose correction from P′ to the actual pose P and generate Binₚ from Bin_{p′} using metadata M, wherein Binₚ has all the spatial cues as per Pose P. In some implementations, pose P′ at the pre-renderer is an assumed pose without any information from light weight device. In some other implementations, pose P′ at the pre-renderer is received from light weight device through a back channel. Computing metadata corresponding to various probing poses such that the lightweight post renderer can do the pose correction from P′ to the actual pose P can require multiple binaural renditions at the pre-renderer, also referred to as pre-renditions in this document, and these pre-renditions may be complexity intensive. Moreover, computing metadata corresponding to multiple probing poses can increase the metadata bitrate significantly. Hence, it is desired to carefully select the probing pose points for pre-renditions such that the total number of pre-renditions can be limited. Moreover, it is also desired to reduce the amount of metadata corresponding to these probing pose points while preserving the overall perceptual quality in the estimated binaural signal Binₚ corresponding to actual pose P at the post renderer. Following embodiments provide example implementations of such low complexity low metadata rate implementations.

### 1-Axis Split Rendering Metadata Calculation

An example case is described where split rendered metadata is calculated with single-axis (e.g., yaw) corrections. This example may employ two pre-renditions (N=2), where the two probing poses are P′+X and P′−X′ and wherein X and X′ are deviations from the reference pose P′ around the axis 101. More specifically, X and X′ may be (yaw) angles α and −α. Note that the deviation from the reference pose is not necessarily equal (±α) but is assumed here for simplifying the description.

One potential way to save pre-renderer complexity is to skip one rendition. This is a workable solution as long as the trend in time of the yaw angle is known. In that case, the probing rendition may be done for just either +α or −α towards which the pose is expected to evolve. However, in general, such a trend may be unknown. For example, the trend is unknown in cases where the current pose is static, since it is unknown whether the user will next turn the head to the right or the left. For this example, if the probing rendition is done in the wrong direction, the adjustments done by the post-renderer would have to rely on extrapolated rather than interpolated metadata, which may reduce the quality of the post-rendered output signal.

A first solution to reducing the number of renditions to two is to give up pre-rendering to the reference pose P′. Instead, pre-renditions are generated for poses P′−α and P′+α and one of these binaural renditions, e.g., for pose P′−α is transmitted to the post-renderer device. In case, pose P at the post-renderer is static and thus identical to P′, the post renderer will thus have to do a correction by +α. The advantage with this over the solution from an approach with three renditions is that the complexity for one rendition is saved and that only a single set of correction metadata needs to be transmitted. One potential disadvantage of the solution is that a correction by the post-renderer will virtually always be needed even if the pose is static. A further potential disadvantage is the bias of the solution with potentially less accurate post-renderer output signal for pose P′+α compared to the (perfect) post-renderer output signal for pose P′−α. This bias may be overcome by transmitting one of the11inaurall channels (e.g. left channel) of the rendition for pose P′−α and one of the binaural channels (e.g. right channel) of the rendition for pose P′+α. The post rendering for pose P will consequently involve adjusting the left channel using renderer metadata relative to the rendition of that channel for pose P′−α and adjusting the right channel using renderer metadata relative to the rendition for pose P′+α.

Another solution for that problem is in the pre-renderer to firstly generate an approximation of the binaural rendition for the reference pose P′ through interpolation between the available renditions for poses P′−α and P′+a. This may simply involve averaging the two available binaural renditions to generate a reference binaural rendition for virtual reference pose P′. Secondly, split renderer metadata can be calculated as described in U.S. Ser. No. 18/864,497 based on the binaural renditions for P′, P′−α and P′+a, whereby it is notable that the fact that the reference rendition is obtained through interpolation creates metadata symmetries which alleviates the need to calculate and transmit metadata associated with one of the probing positions. Thirdly, the reference rendition along with the metadata are transmitted to the post renderer device where operations can take place as described in U.S. Ser. No. 18/864,497, hereby incorporated by reference.

In the following, the above-described solutions are extended generating split renderer metadata for post-renderer corrections for pose deviations around 2 and 3 axes, e.g., for corrections of yaw and pitch deviations or for corrections of yaw, pitch and roll deviations.

### 2-Axes Split Rendering Metadata Calculation

Another example case is described where split rendered metadata is calculated with two-axis (e.g., yaw and pitch) correction. For this example, four probing poses may be considered with a reference pose, where techniques suggested by U.S. Ser. No. 18/864,497 may be carried out. Two probing poses may be employed to probe first axis (e.g., yaw axis) deviations from the reference pose, e.g., by varying the pose relative to the reference pose by deviations of ±α about the first axis while keeping a second axis (e.g., pitch) unchanged. Two other probing poses may be employed to probe pitch deviations from the reference pose, e.g., by varying the pose relative to the reference pose by pitch deviations of ±β while keeping the yaw unchanged. The total number of renditions is five for this example.

In the following description, techniques are described for calculating split renderer metadata for post-renderer corrections about a number of axes. Although the description may refer to yaw, pitch, and/or roll corrections, the same techniques may be applied for computationally efficient calculation of post-renderer metadata around any axis or set of axes. Thus, the terms yaw and pitch and/or roll in the following description could thus be replaced by any other appropriate axis.

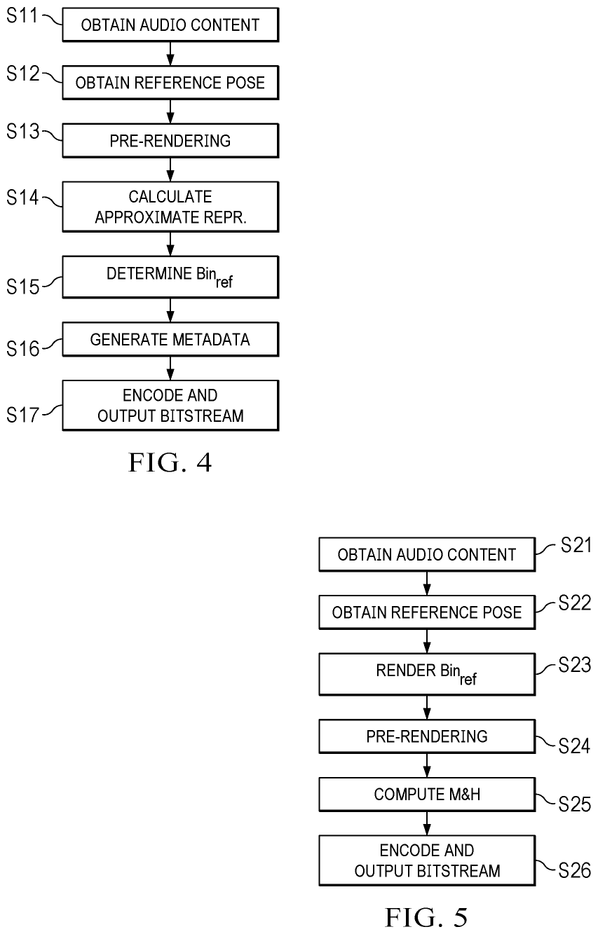

FIG. 4 is a flow chart illustrating processing in the main device 2 in accordance with embodiments of a first aspect of the invention, relating to a method of rendering audio in the main device 2 to enable split rendering with pose correction around multiple rotational axes.

The flow chart may be broken into various blocks or partitions, such as blocks S11-S17. Processing for the various blocks of FIG. 4, which may be described as operations, processes, methods, steps, acts or functions, may commence at block S11.

In step S11 (obtain audio content), a first bitstream is received and decoded (e.g., by decoder 11) to obtain an immersive audio content A. Step S11 may be followed by step S12.

In step S12 (obtain reference pose), a reference pose P′ is obtained. The reference pose may be an assumed pose (e.g. straight ahead) or may be based on pose information received from the lightweight device 3. Step S12 may be followed by step S13.

In step S13 (pre-rendering), a first number of binaural pre-renditions are rendered (e.g., by renderer 12), wherein the binaural pre-renditions correspond to a set of probing poses Pₙ, including poses deviating from the reference pose P′ by rotation around at least one of the rotational axes. Optionally, the set of probing poses also includes the reference pose. Step S13 may be followed by step S14.

In step S14 (calculate approximate representations), a second number of approximate binaural representations Bin′ₘ are calculated based on the binaural pre-renditions Binₙ, wherein the approximate binaural representations Bin′ₘ correspond to a set of virtual probing poses Pₘ, each virtual probing pose (Pₘ) deviating from the probing poses Pₙ by rotation around at least one of the rotational axes. Step S14 may be followed by step S15.

At step S15 (determine Bin_{ref}), a reference binaural representation, Bin_{ref}, is determined. As discussed in more detail in the following, the reference binaural representation Bin_{ref} may be equal to one of the binaural pre-renditions Binₙ or one of the approximate binaural representations Bin′ₘ. The reference binaural representation Bin_{ref} may correspond to the reference pose P′ and may then be a pre-rendition corresponding to the reference pose. A reference binaural representation Bin_{ref} corresponding to the reference pose P′ may also be obtained by linearly combining several pre-renditions. Step S15 may be followed by step S16.

In step S16 (generate M), reconstruction metadata M, which enables reconstruction of the binaural pre-renditions Binₙ and the approximate binaural representations Bin′ₘ from the reference binaural representation Bin_{ref}, is computed.

Steps S14-S16 may all be performed by metadata generator 13 in FIG. 3. If the reference binaural representation is rendered, such rendering may be performed by renderer 12, and the reference binaural representation will be one of the binaural pre-renditions. Step S16 may be followed by step S17.

In step S17 (encode and output bitstream), the reference binaural representation Bin_{ref} and the reconstruction metadata M are encoded (e.g., by encoders 14, 15 or a single encoder) in an output bitstream (b₂), which is subsequently outputted on an appropriate communication channel. The reconstruction metadata may be quantized and encoded based on symmetries in reconstruction metadata. For example, the reconstruction metadata may be encoded using differential coding between metadata relating to different (symmetrical) probing poses.

The step of computing reconstruction metadata (step S16) may include computing axis-specific metadata for each rotational axis. In that case, the method comprises, for each rotational axis, selecting a first set of representations from the binaural pre-renditions Binₙ and the approximate binaural representations Bin′ₘ, this first set of representations corresponding to probing poses deviating from each other by rotation around the axis (e.g. the yaw or pitch axis), and computing axis-specific reconstruction metadata M, H enabling reconstruction of at least one representations in the set from another representation in the set, the axis-specific reconstruction metadata M, H representing deviation around that particular axis.

According to an example solution, the pre-renderer may render binaural presentations for three probing poses P₁, P₂ and P₃.
1. In a first step, pre-rendering takes place to obtain pre-renditions Bin₁ Bin₂ and Bin₃ for the three probing poses P₁, P₂ and P₃ with

$${P}_{1} = {P}^{′} + ( - α , - β )$$

$${P}_{2} = {P}^{′} + ( - α , + β )$$

$${P}_{3} = {P}^{′} + ( + α , 0 )$$

Herein, α denotes a probing angle for deviations around the yaw axis, herein referred to as yaw deviations, and β a corresponding probing angle for deviations around the pitch axis, herein referred to as pitch deviations.
2. In a second step, an approximate binaural presentation Bin′₁ for a virtual probing pose P₄=P′+(−α, 0) is calculated, for instance by interpolating the renditions for P₁ and P₂.
3. In a third step, pitch correction metadata H can be calculated based on pre-renditions Bin₁ and Bin₂ and approximate rendition Bin′₁, using a technique described in U.S. Ser. No. 18/864,497 and with Bin′₁ as reference representation.
4. In a final step, yaw correction metadata M can be calculated based the pre-rendition for probing pose P₃ and the approximate rendition for pose P₄, using a technique described in U.S. Ser. No. 18/864,497 and again with Bin′₁ as reference representation.

It is notable that a sequence of operation steps can be performed for obtaining yaw correction metadata prior to calculating pitch correction metadata. In that case the probing poses P₁, P₂ and P₃ and the virtual probing pose P₄ are given as

$${P}_{1} = {P}^{′} + ( - α , - β )$$

$${P}_{2} = {P}^{′} + ( + α , - β )$$

$${P}_{3} = {P}^{′} + ( 0 , + β )$$

$${P}_{4} = {P}^{′} + ( 0 , - β ) .$$

The yaw and pitch metadata M, H and a binaural reference representation are encoded and transmitted to the lightweight device 3, which enables the lightweight device to perform pose correction. In the above example, approximate rendition Bin′₁ was used as reference for the calculation of both yaw and pitch metadata, and it will be appropriate to encode and transmit this representation.

However, in principle, it is not necessary to use the same reference presentation for both sets of metadata, and in fact the binaural reference rendition to be transmitted to the post-renderer (lightweight device 3) may be any of those available for the probing poses P₁, P₂ and P₃ and the virtual probing pose P₄.

It is also possible to choose a different binaural reference rendition, e.g., associated with virtual reference pose P′. This reference rendition may be obtained through low-complex post-renderer operations based on any (or a combination) of the available pre-renderings for the probing positions and using a technique described in U.S. Ser. No. 18/864,497. It is also possible to obtain the reference rendition directly based on linear or triangular interpolation. Let b₁, b₂ and b₃ denote the binaural pre-renditions for probing poses P₁, P₂ and P₃, an interpolated reference rendition bₚ′ for virtual pose P′ can be obtained by the following weighted averaging:

$${b}_{{p}^{′}} = \frac{1}{4} ( {b}_{1} + {b}_{2} ) + \frac{1}{2} {b}_{3} .$$

As described above in the example with yaw-only correction, the fact that the reference rendition and the approximate rendition for the virtual probing pose P₄ are obtained through interpolation may cause metadata symmetries which may alleviate the need to calculate and transmit metadata associated with some of the probing positions.

### 3-Axes Split Renderer Metadata Calculation

Now, considering the 3 axes case with yaw, pitch and roll correction, the obvious solution would be to consider 6 probing poses and the reference pose and to carry out techniques suggested by U.S. Ser. No. 18/864,497. Two additional probing poses compared to the obvious solution of the 2-axes case would be to probe roll deviations from the reference pose, e.g., by varying the pose relative to the reference pose by roll deviations of ±γ while keeping pitch and yaw unchanged. This would require a total of 7 pre-renditions.

In the following solutions are described for calculating split renderer metadata for post-renderer corrections around three axes. The description assumes yaw, pitch and roll corrections, but the same principles could be applied for computationally efficient calculation of post-renderer metadata around any three (orthogonal) axes. The used entities yaw, pitch and roll in the following description could thus be replaced by any three rotation axes out of yaw, pitch, and roll.

According to an example solution, the pre-renderer may render binaural presentations for only four probing poses P₁, P₂, P₃ and P₄.
1. In a first step, pre-rendering takes place to obtain pre-renditions Bin₁ Bin₂ and Bin₃ for the three probing poses P₁, P₂ and P₃ with

$${P}_{1} = {P}^{′} + ( - α , - β , - γ )$$

$${P}_{2} = {P}^{′} + ( - α , - β , + γ )$$

$${P}_{3} = {P}^{′} + ( - α , + β , 0 )$$

Herein, α denotes a probing angle for yaw deviations, β a corresponding probing angle for pitch deviations and γ a probing angle for roll deviations.
2. In a second step, an approximate rendition Bin′₁ for a virtual probing pose

$${P}_{5} = {P}^{′} + ( - α , - β , 0 )$$

is calculated, for instance by interpolating the renditions for P₁ and P₂.
3. In a third step, roll correction metadata can be calculated based on pre-renditions Bin₁ and Bin₂ and approximate rendition Bin′₁, using a technique described in U.S. Ser. No. 18/864,497 and using Bin′₁ for pose P₅ as reference presentation.
4. In a fourth step, pitch correction metadata can be calculated based the pre-rendition Bin₃ for pose P₃ and the approximate rendition Bin′₁ for virtual probing pose P₅ using a technique described in U.S. Ser. No. 18/864,497 and again using Bin′₁ for pose P₅ as reference presentation.
5. In a fifth step, an approximate rendition Bin′2 for a virtual probing pose

$${P}_{6} = {P}^{′} + ( - α , 0 , 0 )$$

is calculated, for instance by interpolating (e.g., averaging) the renditions for P₃ and P₅ or by carrying out low-complexity post-renderer operations of U.S. Pat. No. 12,604,152 using the pitch correction metadata from step 4 and one or both pre-renditions for probing poses P₃ or/and P₅.
6. In a sixth step, pre-rendering takes place to obtain a fourth pre-rendition Bin₄ for probing pose P₄ with

$${P}_{4} = {P}^{′} + ( + α , 0 , 0 )$$

7. In a final step, yaw correction metadata can be calculated based on the pre-rendition Bin₄ for probing pose P₄ and the approximate rendition Bin′₂ for pose P₆, using a technique described in U.S. Ser. No. 18/864,497 and using either one of the renditions as reference presentation.

As described above, it is possible to do the operation steps to obtain yaw, pitch and roll correction metadata in different orders. The order may also be adapted based on properties of the immersive audio signal. Some of the steps and correction metadata calculations may even be omitted based on such immersive audio signal properties. For instance, for an audio signal with dominant sound arriving from left or right relative to reference pose P′, pitch pose correction can be approximated with a table that contains gain parameters corresponding to various pitch angles. Such a table can be computed once during initialization time and both pre-renderer and post renderer can have prior knowledge about these tables. In these cases, pitch correction metadata is not necessary in the bitstream, and the above steps could be adapted to calculate yaw and roll correction metadata only. Another example is the case with an audio signal with dominant sound arriving from front or rear relative to reference pose P′. In these cases, roll correction metadata is not necessary in the bitstream, and roll pose correction can be approximated with a table that contains gain parameters corresponding to various roll angles.

As discussed above, the binaural reference rendition (representation) to be transmitted to the post-renderer may be any of the pre-renditions for the exercised probing poses or any of the approximated pre-renditions at the virtual probing poses. In addition, any other approximated binaural pre-rendition can be used as reference rendition based on the available pre-renditions. A reference rendition may be obtained through low-complex post-renderer operations based on any (or a combination) of the available pre-renderings for the probing positions and using a technique described in U.S. Ser. No. 18/864,497. An approximation of the pre-rendition for the reference pose can be obtained through interpolation between the available pre-renditions.

According to one example, the approximated rendition for reference pose P′ can be obtained from the available pre-renditions for probing poses P₁ through P₄. Let b₁ through b₄ denote the binaural pre-renditions for probing poses P₁ through P₄, an interpolated reference rendition bp′ for virtual pose P′ can be obtained by the following weighted averaging:

$${b}_{{P}^{′}} = \frac{1}{8} ( {b}_{1} + {b}_{2} ) + \frac{1}{4} {b}_{3} + \frac{1}{2} {b}_{4} .$$

Notwithstanding the above, if complexity constraints allow, it may be preferable to additionally generate a pre-rendition for the reference pose P′ and to transmit this signal as reference rendition to the post-renderer. The availability of a pre-rendition for the reference pose P′ may also be used to enhance the yaw metadata calculation in step 8 above.

### Iterative Split Renderer Metadata Enhancement

The above examples of complexity-reduced split renderer metadata calculation for post-renderer corrections have a certain bias. For instance, in the 3-axes case, roll correction metadata is calculated for yaw and pitch angle deviations from the reference pose P′ of −α and −β. This makes the obtained roll correction metadata less precise for the more likely case that the yaw and pitch angles of the pose corresponds to those of the reference pose P′. It would thus be more correct to calculate the roll correction metadata for yaw and pitch angle deviations equal to 0. Likewise, the pitch correction metadata is biased since it is calculated for a yaw deviation angle of −α rather than 0. The bias in the metadata calculations may in turn cause inaccuracies in the renditions obtained by the post-renderer using that biased metadata.

In the following an iterative enhancement technique is described that can mitigate the described bias and the resulting post-renderer inaccuracies. It is assumed that a binaural rendition for the reference pose P′ is available. Reference is made to the above procedural description of the 3 axes case with yaw, pitch and roll correction.

In a first enhancement step, roll correction metadata is enhanced using the reference pose P′ and the virtual probing poses

$${P}_{7} = {P}^{′} + ( 0 , 0 , - γ ) , \\ as \\ {P}_{8} = {P}^{′} + ( 0 , 0 , + γ ) .$$

Part of this procedure is the calculation of approximate renditions for these virtual probing poses, for instance by carrying out low-complexity post-renderer operations of U.S. Pat. No. 12,604,152 or U.S. Ser. No. 18/864,497 using the previously calculated pitch and yaw correction metadata from the steps above and the pre-renditions for probing poses P₁ and P₂. With these approximate renditions and the rendition for the reference pose P′, roll correction metadata is re-calculated, e.g., using a technique described in U.S. Ser. No. 18/864,497.

In a corresponding second enhancement step, pitch correction metadata is enhanced using the reference pose P′ and the virtual probing poses

$${P}_{9} = {P}^{′} + ( 0 , - β , 0 ) , \\ {P}_{10} = {P}^{′} + ( 0 , + β , 0 ) .$$

Part of this procedure is the calculation of approximate renditions for these virtual probing poses, for instance by carrying out low-complexity post-renderer operations of U.S. Pat. No. 12,604,152 or U.S. Ser. No. 18/864,497 using the previously calculated roll and yaw correction metadata and/or the previously performed pre-renditions. For instance, an approximate rendition for pose P₉ can be calculated by interpolating (e.g., averaging) between the pre-renditions for poses P₁ and P₂ followed by adjusting that rendition with regards to changing the yaw deviation angle from −α to 0 applying the post-renderer technique using the previously calculated yaw correction metadata. The interpolating operations between the pre-renditions for poses P₁ and P₂ may also involve applying post-renderer techniques using the previously enhanced roll correction metadata. An approximate rendition for pose P₁₀ can be calculated using the pre-rendition for probing pose P₃ applying post-rendering techniques using the previously calculated yaw correction metadata.

In a corresponding third enhancement step, yaw correction metadata is enhanced using the pre-renditions for reference pose P′ and probing pose P₄ and an approximate rendition for virtual probing pose P₆. This enhancement step may involve applying post-renderer operations using the previously enhanced roll and pitch metadata and the available pre-renditions for probing poses P₁, P₂, and/or P₃.

Each of the above-described metadata enhancement steps relies on previously calculated metadata. It is thus possible to achieve even more enhancements by carrying out multiple iterations.

### Low Complexity, Low Side Information (Metadata) Pre-Renditions for Yaw and Pitch Correction

FIG. 5 is a flow chart illustrating processing in the main device 2 in accordance with embodiments of a second aspect of the invention, relating to a method of rendering audio to facilitate split rendering with pose correction around yaw axis and pitch axis.

The flow chart may be broken into various blocks or partitions, such as blocks S21-S26. Processing for the various blocks of FIG. 5, which may be described as operations, processes, methods, steps, acts or functions, may commence at block S21.

In step S21 (obtain audio content), a first bitstream is received and decoded (e.g., by decoder 11) to obtain an immersive audio content A and in step S22 (obtain reference pose) a reference pose P′ is obtained. The reference pose may be an assumed pose (e.g. straight ahead) or may be based on pose information received from the lightweight device 3. Step S21 may be followed by step S22.

At step S23 (render Bin_{ref}), the immersive audio content A is rendered (e.g., by renderer 12) into a reference binaural representation, Bin_{ref}, corresponding to a reference pose P′. Step S23 may be followed by step S24.

At step S24 (pre-rendering), the immersive audio content A is rendered (e.g., by renderer 12) into two binaural pre-renditions Binₙ, wherein the binaural pre-renditions correspond to two probing poses Pₙ deviating from the reference pose by rotation around both yaw and pitch axes. In other words, each probing pose deviates form the reference pose by rotation around a probing axis 104 (see FIG. 2) with the same origin as the yaw and pitch axes, and extending between the yaw axis 101 and the pitch axis 102. The deviation in yaw and pitch may be equal, in which case the probing axis 104 extends symmetrically between the yaw and pitch axis (i.e., 45 degrees from each axis). Step S24 may be followed by step S25.

In step S25 (compute M and H), yaw metadata M representing a deviation around the yaw axis, and pitch metadata H representing deviation around the pitch axis are computed (e.g. by metadata generator 13) for each probing pose Pₙ. Step S25 may be followed by step S26.

In step S26 (encode and output bitstream), the reference binaural representation Bin_{ref} and the yaw metadata M and the pitch metadata HI are encoded (e.g., by encoders 14, 15) in an output bitstream b₂, which is subsequently outputted on an appropriate communication channel. The yaw and pitch metadata may be quantized and encoded based on symmetries in reconstruction metadata. For example, the metadata may be encoded using differential coding between metadata relating to different (symmetrical) probing poses.

As discussed in more detail below, the step of computing yaw metadata and pitch metadata involves computing complete reconstruction metadata \hat{M} to enable reconstruction of the binaural pre-renditions Binₙ from the reference binaural representation Bin_{ref}, and then computing the yaw and pitch metadata based on the complete reconstruction metadata. Such complete reconstruction metadata may include, for each time-frequency tile, a complex or real 2×2 transformation matrix \hat{M}.

The yaw metadata may include, for each time-frequency tile, a complex or real 2×2 yaw correction matrix M. The pitch metadata may include, for each time-frequency tile, a real 2×2 diagonal pitch correction matrix H.

In an example implementation, the light-weight post renderer device 3 sends the reference head pose P′ to the heavy weight pre renderer device 2 through a back channel. The heavy weight device uses the P′ pose to generate a reference binaural signal Bin_{p′} and metadata such that the post renderer can do the pose correction from P′ to the actual pose P and generate Binₚ from Bin_{p′} using the metadata, wherein Binₚ has all the spatial cues as per Pose P. The deviation between P′ and P depends on the motion-to-sound latency as described in this document.

Let the 3DOF pose angles along yaw, pitch and roll axes in pose P′ be α_{ref},β_{ref},γ_{ref} respectively and the deviations in the angles along yaw, pitch and roll axes between P and P′ be α_{d},β_{d},γ_{d}. It has been observed that it is more perceptually important to correct da (or deviation along yaw axis) than β_{d} and γ_{d} (Pitch and roll deviations). Furthermore, deviations along pitch axis are more relevant to user applications than deviations along roll axis.

In an example implementation, a low complexity and low metadata rate solution is proposed to correct α_{d} and β_{d} wherein, the heavy weight device uses the reference pose P′ to generate a reference binaural signal Bin_{p′} and two additional renditions are computed as per the probing head poses shown below

$${P}_{1} = {P}^{′} + ( α , β , 0 ) , \\ {P}_{2} = {P}^{′} + ( - α , - β , 0 ) .$$

Prediction parameters are computed as per U.S. Ser. No. 18/864,497 with modifications as shown below. First, a prediction matrix is computed as per U.S. Ser. No. 18/864,497

$${\hat{M}}_{{p}_{1}} = {{R}_{y , {p}_{1} , {p}^{′}} ( {R}_{y , {p}^{′} , {p}^{′}} + I ϵ )}^{- 1}$$

where R_{y,p′,p′} is the covariance matrix of left and right channels of reference binaural signal Bin_{p′}, and R_{y,p1,p′} is the covariance matrix of reference binaural signal and binaural signal Binₚ₁ generated with pose P₁.

As used below, R_{y,p1,p1} is the covariance matrix of left and right channels of binaural signal Binₚ₁ that is generated with pose P₁.

With the above prediction matrix, a post prediction matrix is computed

$${R}_{\hat{y} , {p}_{1} , {p}_{1} ,} = {\hat{M}}_{{p}_{1}} {R}_{y , {p}^{′} , {p}^{′}} {\hat{M}}_{{p}_{1}}^{*}$$

It can be assumed that, if α is small then the overall energy of binaural signal that is rendered with pose P′+(α, 0, 0) is same as overall energy of binaural signal that is rendered with pose P′ and any energy difference between P₁ and P′ is coming from Pitch angle β. Based on this assumption the prediction matrix \hat{M}ₚ₁ can be scaled such that overall energy of post prediction matrix is same as Bin_{p′} and an additional one or more real only scale factor can be computed to make up for pitch gain. With these parameters, Binₚ₁ can be estimated as

$${Bin}_{p 1 [ 2 x 1 ]}^{′} = {H}_{p 1} {G}_{{p}_{1}} {\hat{M}}_{{p}_{1}} {Bin}_{{p}^{′} [ 2 x 1 ]} \\ here , \\ {G}_{p 1} = [ \begin{matrix}{g}_{l , p 1} & 0 \\ 0 & {g}_{r , p 1}\end{matrix} ]$$

where Hₚ₁ is the gain parameter to model pitch change from P′ to \hat{P}₁ and is given as

$$= [ \begin{matrix}{h}_{l , p 1} & 0 \\ 0 & {h}_{r , p 1}\end{matrix} ]$$

It can be shown that

$${g}_{l , p 1} = sqrt ( \frac{{R}_{y , {p}^{′} , {p}^{′}} ( 1 , 1 )}{{R}_{\hat{y} , p 1 , p 1} ( 1 , 1 )} ) , \\ {g}_{r , p 1} = sqrt ( \frac{{R}_{y , {p}^{′} , {p}^{′}} ( 2 , 2 )}{{R}_{\hat{y} , p 1 , p 1} ( 2 , 2 )} \\ {h}_{l , p 1} = sqrt ( \frac{{R}_{y , p 1 , p 1} ( 1 , 1 )}{{R}_{y , {p}^{′} , {p}^{′}} ( 1 , 1 )} ) , \\ {h}_{r , p 1} = sqrt ( \frac{{R}_{y , p 1 , p 1} ( 2 , 2 )}{{R}_{y , {p}^{′} , {p}^{′}} ( 2 , 2 )}$$

Hₚ₁ and Mₚ₁=Gₚ_{₁} \hat{M}ₚ_{₁} are quantized and coded. Similarly, parameters corresponding to P₂ pose computed and coded. These coded bits are then multiplexed with coded Bin_{p′} bits and transmitted to post renderer. The post renderer decodes Hₚ₁, Mₚ₁, Hₚ₂, Mₚ₂ and Bin_{p′[2×1]}. Furthermore, if the actual pose P at the post renderer is not equal to either P₁ or P₂ or P′ then the parameters corresponding to pose P₁ or P₂ or both are interpolated or extrapolated using linear interpolation that includes choosing two pose points out of P′, P₁ and P₂ that are closest to pose P, where in the two pose points may be different for yaw and pitch interpolation or extrapolation. Then the parameters M and H are interpolated or extrapolated between the two chosen pose points using linear interpolation. In an example implementation, if interpolated parameters are Hₚ and Mₚ then binaural signal corresponding to Binₚ can be computed as

$${Bin}_{p [ 2 x 1 ]} = {H}_{p} {M}_{p} {Bin}_{{p}^{′} [ 2 x 1 ]}$$

In some embodiments,

$${h}_{l , p 1} = {h}_{r , p 1} = sqrt ( \frac{{R}_{y , p 1 , p 1} ( 1 , 1 ) + {R}_{y , p 1 , p 1} ( 2 , 2 )}{{R}_{y , {p}^{′} , {p}^{′}} ( 1 , 1 ) + {R}_{y , {p}^{′} , {p}^{′}} ( 2 , 2 )} ) \\ and \\ {h}_{l , p 2} = {h}_{r , p 2} = sqrt ( \frac{{R}_{y , p 2 , p 2} ( 1 , 1 ) + {R}_{y , p 2 , p 2} ( 2 , 2 )}{{R}_{y , {p}^{′} , {p}^{′}} ( 1 , 1 ) + {R}_{y , {p}^{′} , {p}^{′}} ( 2 , 2 )} )$$

which means only one pitch gain parameter needs to be coded for both left and right channel in a given time frequency tile.

### Choosing Pre-Renditions Based on Perceptual Importance

In an example implementation, the number of pre-renditions may be controlled by choosing the pose points based on perceptual importance as follows. Let the 3DOF pose angles along yaw, pitch and roll axes in pose P′ be α_{ref},β_{ref},γ_{ref} respectively and the deviations in angles along yaw, pitch and roll axes between P and P′ be α_{d},β_{d},γ_{d}. It has been observed that it is more perceptually important to correct da (or deviation along yaw axis) than β_{d} and γ_{d} (Pitch and roll deviations) and it is desired to do the pose correction along yaw axis as accurate as possible. For this reason, it is desired to have more probing pose points to generate yaw only related side information as compared to the number of probing pose points for pitch and roll related side information. Furthermore, deviations along pitch axis are most likely more relevant to user applications than deviations along roll axis and hence it may be desired to have more probing pose points to generate pitch related side information as compared to the number of probing pose points to generate roll related side information. In an example implementation, following probing pose points are selected to generate side information for rotations along yaw, pitch and roll axes.

$${P}_{1} = {P}^{′} + ( α , 0 , 0 ) \\ {P}_{2} = {P}^{′} + ( - α , 0 , 0 ) \\ {P}_{3} = {P}^{′} + ( 0 , β , 0 ) \\ {P}_{4} = {P}^{′} + ( 0 , 0 , γ )$$

Side information corresponding to P₁ and P₂ can be computed as per U.S. Ser. No. 18/864,497. To compute the side information corresponding to P₃ it can be assumed that ITD (interaural time difference) cues do not change with pitch angle and a deviation in pose along pitch axis can be modelled using one or more real only gain parameters. These gain parameters can be computed as

$${H}_{p 3} = [ \begin{matrix}{h}_{l , p 3} & 0 \\ 0 & {h}_{r , p 3}\end{matrix} ] , \\ here \\ {h}_{l , p 3} = sqrt ( \frac{{R}_{y , p 3 , p 3} ( 1 , 1 )}{{R}_{y , {p}^{′} , {p}^{′}} ( 1 , 1 )} ) , \\ {h}_{r , p 3} = sqrt ( \frac{{R}_{y , p 3 , p 3} ( 2 , 2 )}{{R}_{y , {p}^{′} , {p}^{′}} ( 2 , 2 )}$$

where, R_{y,p′,p′} is the covariance matrix of reference binaural signal Bin_{p′}, R_{y,p3,p3} is the covariance matrix of reference binaural signal Binₚ₃ that is generated with with pose P₃.

Hₚ₃ is quantized and coded and multiplexed into bitstream along with the coded bits for yaw and roll related side information and coded Bin_{p′} signal.

In some implementations,

$${h}_{l , p 3} = {h}_{r , p 3} = sqrt ( \frac{{R}_{y , p 3 , p 3} ( 1 , 1 ) + {R}_{y , p 3 , p 3} ( 2 , 2 )}{{R}_{y , p ′ , p ′} ( 1 , 1 ) + {R}_{y , p ′ , p ′} ( 2 , 2 )} )$$

which means only one pitch gain parameter needs to be coded for both left and right channels in a given time frequency tile.

Deviation in roll angle may change ITD cues and hence it may be desired to model roll deviation with complex gain parameters in low frequencies (e.g., 0-2 kHz) and with real only gain parameters in high frequencies (e.g., above 2 kHz). Side information corresponding to roll probing pose P₄=P′+(0, 0, γ) can be computed as follows:

Prediction parameters may be computed as per U.S. Ser. No. 18/864,497 with modifications as shown below. In an example implementation, same modifications are applied to the side information corresponding to yaw probing poses, Mₚ_{₁} and Mₚ_{₂}. First, a prediction matrix may be computed as

$${\hat{M}}_{{p}_{4}} = {{R}_{y , {p}_{4} , p ′} ( {R}_{y , p ′ , p ′} + I ϵ )}^{- 1}$$

where, R_{y,p′,p′} is the covariance matrix of reference binaural signal Bin_{p′}, R_{y,p}_{₄}_{,p′} is the covariance matrix of ref binaural signal and binaural signal with probing pose \hat{P}₄. R_{y,p4,p4} is the covariance matrix of reference binaural signal Binₚ₄ that is generated with probing pose \hat{P}₄.

With the above prediction matrix, a post prediction matrix is computed as

$${R}_{\hat{y} , {p}_{4} , {p}_{4} ,} = {\hat{M}}_{{p}_{4}} {R}_{y , p ′ , p ′} {\hat{M}}_{{p}_{4}}^{*}$$

To further energy match the post-prediction matrix, additional gain matrix Gₚ₄ is computed as
here,

$${G}_{p 4} = [ \begin{matrix}{g}_{l , p 4} & 0 \\ 0 & {g}_{r , p 4}\end{matrix} ] , \\ and \\ {g}_{l , p 4} = sqrt ( \frac{{R}_{y , p 4 , p 4} ( 1 , 1 )}{{R}_{\hat{y} , p 4 , p 4} ( 1 , 1 )} ) , \\ {g}_{r , p 4} = sqrt ( \frac{{R}_{y , p 4 , p 4} ( 2 , 2 )}{{R}_{\hat{y} , p 4 , p 4} ( 2 , 2 )}$$

Mₚ_{₄}=Gₚ_{₄} \hat{M}ₚ_{₄} are quantized and coded and multiplexed into bitstream along with the coded bits for yaw and pitch related side information and coded Bin_{p′} signal.

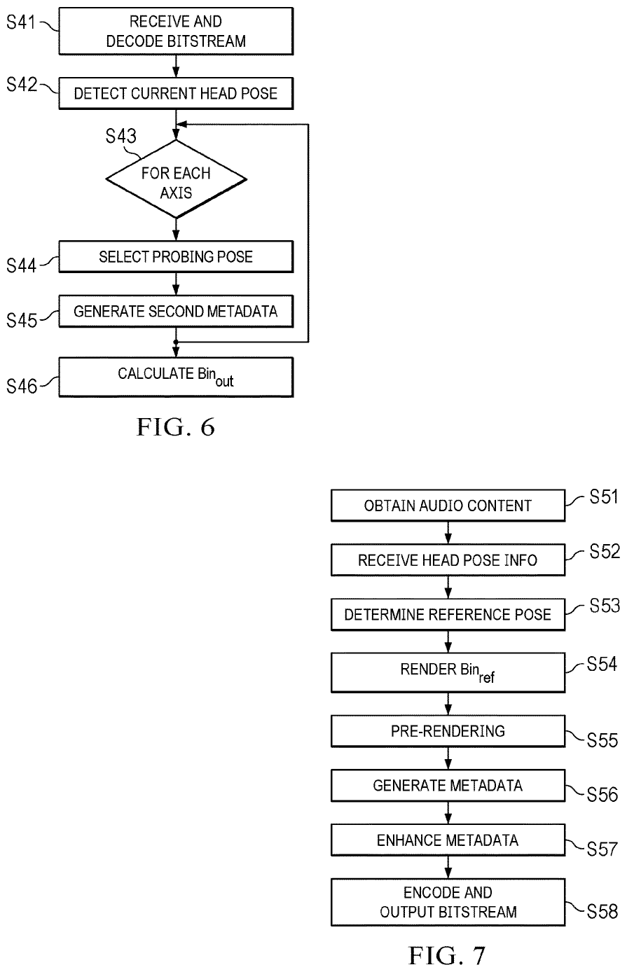

FIG. 6 is a flow chart illustrating processing in the lightweight device 3 in accordance with embodiments of a further aspect of the invention, relating to a method of split rendering with pose correction around multiple rotational axes.

The flow chart may be broken into various blocks or partitions, such as blocks S41-S45. Processing for the various blocks of FIG. 6, which may be described as operations, processes, methods, steps, acts or functions, may commence at block S41.

In step S41 (receive and decode bitstream), a bitstream is received and decoded (e.g., by decoders 22, 23) from a main device (e.g., main device 2) to obtain a reference binaural representation Bin_{ref} and first reconstruction metadata M, H associated with a set of probing poses Pₙ representing deviation from a reference pose P′ by rotation around the multiple rotational axes. Step S41 may be followed by step S42.

In step S42 (detect current head pose), a current head pose P is detected (e.g., by head-tracker 25). Step S42 may be followed by step S43.

Step S43 (for each axis) is the beginning of a loop that includes one or more of steps S44-S45. The loop is performed for each of the rotational axes, e.g., for yaw, pitch and roll, respectively. Step S43 may be followed by step S44 when additional processing is required for additional rotational axis. Otherwise step S43 may be followed by step S46 when processing is not required for any additional rotational axis.

In step S44 (select probing pose), a probing pose closest to the detected pose along the particular rotation axis is selected. Step S44 may be followed by step S45.

In step S45 (generate second metadata) second, axis-specific reconstruction metadata M_{α}, M_{β}, M₇ is determined based on the first metadata associated with the selected probing pose and a difference between the reference pose and the current head pose along the particular rotational axis. Step S46 may be followed by step S43 or step S46 when the processing loop is complete.

In step S46 (determine Binₒᵤₜ) a binaural output Binₒᵤₜ corresponding to the current head pose is determined based on the reference binaural representation Bin_{ref} and the second, axis-specific reconstruction metadata for each rotational axis.

An indication of the reference pose (P′) may be obtained from the bitstream. Alternatively, in embodiments where an indication of the current head pose (P) is transmitted to the main device, the reference pose (P′) can be determined based on an expected delay of transmission to the main device.

The set of probing poses may be obtained from the bitstream, but may also be obtained by adding a set of offsets to the reference pose. Such offsets may be pre-defined (e.g., known before-hand) or may be obtained from the bitstream.

Returning to the specific example, at the post renderer, the estimation of left and right channels of binaural signal corresponding to actual pose P is given as

$$[ \begin{matrix}{bin}_{l , p} [ n ] \\ {bin}_{r , p} [ n ]\end{matrix} ] = {M}_{p} [ \begin{matrix}{bin}_{l , p ′} [ n ] \\ {bin}_{r , p ′} [ n ]\end{matrix} ]$$

where:

$${M}_{p} = {M}_{γ} {M}_{β} {M}_{α}$$

M_{α} is computed from Mₚ_{₁}, Mₚ_{₂} and M_{p′}, where M_{p′} is a 2×2 identity matrix, by choosing two pose points out of P₁, P₂, P′ that are closest to pose P around the yaw axis and then performing linear interpolation or extrapolation on the prediction matrix M corresponding to these pose points.
M_{β} is computed by performing linear interpolation or extrapolation on Hₚ₃, and M_{p′} based on the pitch angle in pose P and pitch angle in P₃ and P′.
M_{γ} is computed by performing linear interpolation or extrapolation on Mₚ_{₄}, and M_{p′} based on the roll angle in pose P and roll angle in P₄ and P′.
In an example implementation, g_{d,p} is not transmitted to the post renderer and M matrix is computed with an additional gain matrix G as mentioned above.

It is noted that the additional gain matrix G, which here was computed with respect to pose P₄, may be computed for any pre-rendition including P₁ and P₂. The combination of matrix \hat{M}, computed as disclosed in U.S. Ser. No. 18/864,497 for a specific pose, and the additional gain matrix G computed for the same pose, is an advantageous way of generating metadata for split-rendering, new to the art.

FIG. 7 is a flow chart illustrating processing in the main device 2 in accordance with embodiments of a yet further aspect of the invention. The flow chart may be broken into various blocks or partitions, such as blocks S51-S58. Processing for the various blocks of FIG. 7, which may be described as operations, processes, methods, steps, acts or functions, may commence at block S51.

In step S51 (obtain audio content), a first bitstream is received and decoded (e.g., by decoder 11) to obtain an immersive audio content A. Step S51 may be followed by step S52.

At step S52 (receive head pose info) a second bitstream is received and decoded (e.g., by decoder 17) to receive head pose information P associated with a user of a lightweight processing device. Step S52 may be followed by step S53.

In step S33 (determine reference pose), a reference pose P′ is determined (e.g. in decoder 17) based on the received head pose information. Step S53 may be followed by step S54.

In step S54 (render Bin_{ref}), the immersive audio content A is rendered into a reference binaural representation Bin_{ref} corresponding to a reference pose (e.g., by renderer 12). Step S54 may be followed by step S55.

In step S55 (pre-rendering) the immersive audio content A is rendered (e.g., by rendered 12) into one or more binaural pre-renditions Binₙ the pre-renditions corresponding to one or more probing poses Pₙ deviating from the reference pose about a rotational axis. Step S55 may be followed by step S56.

In step S56 (generate metadata), reconstruction metadata is computed (e.g., by metadata generator 13) to enable reconstruction of the binaural pre-renditions Binₙ from the reference binaural representation Bin_{ref}. The reconstruction metadata includes, for each time-frequency tile, a transformation matrix \hat{M}. Step S56 may be followed by step S57.

In step S57 (enhance metadata), enhanced metadata M is computed (e.g., by metadata generator 13) by multiplying each reconstruction matrix \hat{M} for a specific pose P₅ with an additional gain matrix G, the additional gain matrix having the form:

$${G}_{p} = [ \begin{matrix}{g}_{l , p s} & 0 \\ 0 & {g}_{r , p s}\end{matrix} ] , \\ {g}_{l , p s} = sqrt ( \frac{{R}_{y , p s , p s} ( 1 , 1 )}{{R}_{\hat{y} , p s , p s} ( 1 , 1 )} ) , \\ {g}_{r , p s} = sqrt ( \frac{{R}_{y , p s , p s} ( 2 , 2 )}{{R}_{\hat{y} , p s , p s} ( 2 , 2 )} ) ,$$

where:
R_{y,ps,ps} represents a 2×2 covariance matrix of the binaural pre-rendition for the specific pose Pₛ, and
R_{ŷ,ps,ps} represents a 2×2 covariance matrix of the reconstructed binaural pre-rendition for the specific pose P.

It may be advantageous to have at least two pre-renditions for each rotational axis. The rotational axis may be the yaw axis and/or the roll axis. For the yaw and roll axis, it can be shown that a variance of left and right channels after application of the enhanced metadata M is substantially equal to variance of left and right channels of the reference binaural representation.

In step S58 (encode and output bitstream), the reference binaural representation Bin_{ref} and the enhanced metadata M are encoded (e.g., by encoders 14, 15) in an output bitstream b₂, which is subsequently outputted on an appropriate communication channel. The enhanced metadata may be quantized and encoded based on symmetries in reconstruction metadata. For example, the metadata may be encoded using differential coding between metadata relating to different (symmetrical) probing poses.

The approach outlined in steps S51-58 may be combined with pitch metadata as discussed above. In that case, the set of probing poses includes pitch probing poses deviating from the reference pose only by rotation around the pitch axis. Further, pitch reconstruction metadata is calculated, to enable reconstruction of binaural pre-renditions Binₙ corresponding to the pitch probing poses from the reference binaural representation Bin_{ref}, wherein the pitch reconstruction metadata includes, for each time-frequency tile, a diagonal real 2×2 pitch correction matrix H.

As discussed above, the elements of the pitch correction matrix

$${H}_{{P}_{1}} = [ \begin{matrix}{h}_{l} & 0 \\ 0 & {h}_{r}\end{matrix} ]$$

for a pose P₁ may be obtained as:

$${h}_{l} = sqrt ( \frac{{R}_{y , p 1 , p 1} ( 1 , 1 )}{{R}_{y , p ′ , p ′} ( 1 , 1 )} ) , \\ {h}_{r} = sqrt ( \frac{{R}_{y , p 1 , p 1} ( 2 , 2 )}{{R}_{y , p ′ , p ′} ( 2 , 2 )} )$$

where R_{y,p′,p′} is the covariance matrix of reference binaural presentation Bin_{p′}, and R_{y,p1,p1} is the covariance matrix of a binaural pre-rendition for pose P₁.

Alternatively, the elements of the pitch correction matrix

$${H}_{{P}_{1}} = [ \begin{matrix}h & 0 \\ 0 & h\end{matrix} ]$$

for a pose P₁ are obtained as:

$${h}_{l} = sqrt ( \frac{{R}_{y , p 1 , p 1} ( 1 , 1 ) + {R}_{y , p 1 , p 1} ( 2 , 2 )}{{R}_{y , p ′ , p ′} ( 1 , 1 ) + {R}_{y , p ′ , p ′} ( 2 , 2 )} )$$

where R_{y,p′,p′} is the covariance matrix of reference binaural presentation Bin_{p′}, and R_{y,p1,p1} is the covariance matrix of a binaural pre-rendition for pose P₁.

### Choosing Pre-Renditions Based on Head Movement Velocity and Direction

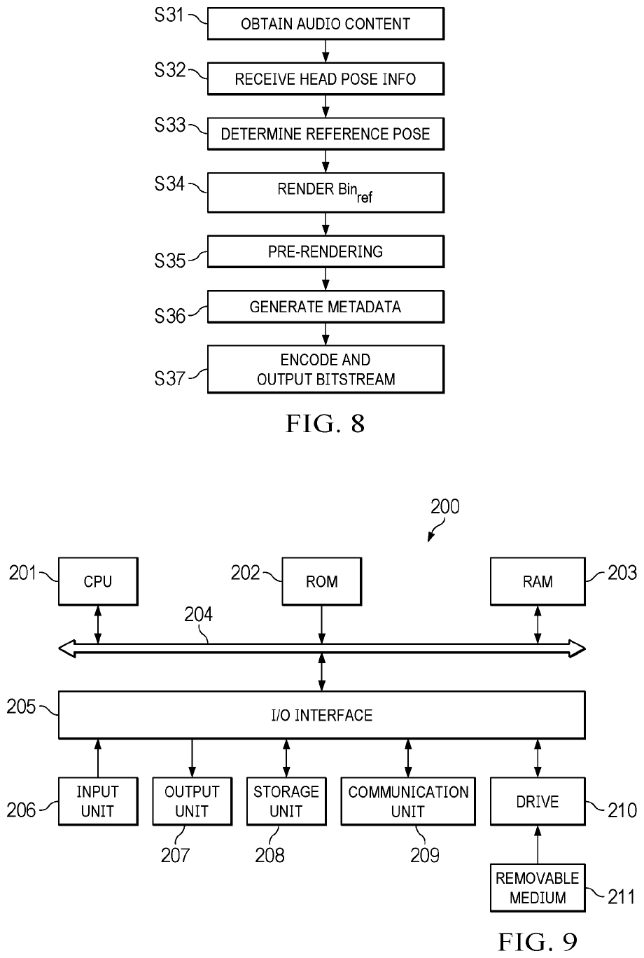

FIG. 8 is a flow chart illustrating processing in the main device 2 in accordance with embodiments of a still further aspect of the invention. The flow chart may be broken into various blocks or partitions, such as blocks S31-S37. Processing for the various blocks of FIG. 8, which may be described as operations, processes, methods, steps, acts or functions, may commence at block S31.

In step S31 (obtain audio content), a first bitstream is received and decoded (e.g., by decoder 11) to obtain an immersive audio content A. Step S31 may be followed by step S32.

At step S32 (receive head pose info) a second bitstream is received and decoded (e.g., by decoder 17) to receive head pose information (P, Ω_{P}, ω_{P}) associated with a user of a lightweight processing device. Step S32 may be followed by step S33.

In step S33 (determine reference pose), a reference pose P′ and at least one of a head pose rotation axis ω_{P} and a head pose rate of rotation ω_{P} is determined (e.g. in decoder 17) based on the received head pose information. Step S33 may be followed by step S34.

In step S34 (render Bin_{ref}), the immersive audio content A is rendered (e.g., by renderer 12) into a reference binaural representation, Bin_{ref}, corresponding to a reference pose P′. Step S34 may be followed by step S35.

In step S35 (pre-rendering), the immersive audio content (A) is rendered (e.g., by renderer 12) into a set binaural pre-renditions Binₙ, wherein the binaural pre-renditions correspond to a set of probing poses Pₙ rotated with respect to the reference pose, wherein the probing poses are selected based on the head pose information (P, Ω_{P}, ω_{P}). Step S35 may be followed by step S62.

In step S36 (compute M), reconstruction metadata M is computed (e.g. by metadata generator 13), to enable reconstruction of the binaural pre-renditions Binₙ from the reference binaural representation Bin_{ref}. Step S36 may be followed by step S37.

In step S37 (encode and output bitstream), the reference binaural representation Bin_{ref} and the reconstruction metadata M are encoded (e.g., by encoders 14, 15) in an output bitstream b₂, which is subsequently output on an appropriate communication channel. The reconstruction metadata may be quantized and encoded based on symmetries in reconstruction metadata. For example, the reconstruction metadata may be encoded using differential coding between metadata relating to different (symmetrical) probing poses.

As will be discussed further below, when a head pose rotation axis ∩_{P} is determined, the probing poses Pₙ may deviate from the reference pose P′ by rotation around this head pose rotation axis Ω_{P}. The probing poses Pₙ may be symmetrically distributed around the reference pose P′. Also in this example, the probing poses Pₙ may include only one probing pose around each rotational degree of freedom. For example, if probing poses are selected around the yaw and pitch axes, then

Further, when a head pose rate of rotation op is determined, when the head pose rate of rotation ω_{P} is below a predefined threshold value the probing poses Pₙ may be selected to deviate from the reference pose by less than a first angle ω_{lower}, and when the head pose rate of rotation ω_{P} is above the threshold value the probing poses Pₙ may deviate from the reference pose by more than a second angle ωᵤₚₚₑᵣ, wherein the first angle ω_{lower} is smaller than the second angle ωᵤₚₚₑᵣ.

In an example implementation, a light-weight post renderer device 3 sends the reference head pose P′ to heavy weight pre renderer device 2 through a back channel. The heavy weight device uses the P′ to generate a reference binaural signal Bin_{p′} and metadata M such that the post renderer can do the pose correction from P′ to the actual pose P and generates Binₚ from Bin_{p′} using the metadata, wherein Binₚ has all the spatial cues as per pose P. The deviation between P′ and P depends on the motion-to-sound latency.

Here, the number of pre-renditions are controlled by choosing the pose points based on an estimation of the head movement velocity (rate of rotation, ω_{P}) or direction of head movement (head pose rotation axis, ω_{P}) or both. With the pose information from post renderer device, the head movement velocity and direction of movement can be computed at the pre-renderer 2. In some implementations, post-renderer may provide the velocity and direction of movement along with pose information. With this information, the pre-renderer can significantly reduce the number of probing pose points for pre-renditions by choosing the probing pose points along the axis of head movement.

For example, if the pose from post renderer is P′ and the head is rotating around the yaw axis, then following probing pose points can be selected to generate side information

$${P}_{1} = {P}^{′} + ( α , 0 , 0 ) \\ {P}_{2} = {P}^{′} + ( - α , 0 , 0 )$$

Here, P′ is the reference pose from post renderer and P′+(α,0,0) is a pose rotated around the head movement axis (in this case the yaw axis), in the direction of head movement.

In general, following probing pose points can be selected to generate side information

$${P}_{1} = {P}^{′} + ( α , β , γ ) \\ {P}_{2} = {P}^{′} + ( - α , - β , - γ )$$

where P′ is the reference pose from post renderer and P′+(α,β,γ) is a pose rotated around the head movement axis ω_{P}, in the direction of head movement.

In an example implementation, velocity and acceleration of head movement is used to further limit the number of pose points to one to generate side information. It can be shown that if delay between post renderer and pre renderer is known and is less than a threshold, and if head is accelerating then the pre-rendition corresponding to following probing pose point is enough to generate side information as

$${P}_{1} = {P}^{′} + ( α , β , γ )$$

where P′ is the reference pose from post renderer and P′+(α,β,γ) is a pose rotated around the head movement axis ω_{P}, in the direction of head movement.

Side information can be computed as per U.S. Ser. No. 18/864,497.

If the head is stationary, that is zero velocity, then following probing pose points can be selected to generate side information as

$${P}_{1} = {P}^{′} + ( α , 0 , 0 ) \\ {P}_{2} = {P}^{′} + ( 0 , β , 0 ) \\ {P}_{3} = {P}^{′} + ( 0 , 0 , γ )$$

Given that head is stationary (or, more generally, the head pose rate of rotation Op is below a given threshold), it can be safely assumed that the deviation in angles along yaw, pitch and roll axes between reference P′ at the pre-renderer and actual pose P at the post-render will be smaller than the deviation along yaw, pitch and roll axes if the head was non-stationary (or rotated faster). With this assumption, α, β and γ in the probing pose points can be set to a lower value (e.g. smaller than a lower boundary ω_{lower}) and would be sufficient to extrapolate the side information corresponding to −α, −β and −γ. In an example implementation, the value of α, β and γ is controlled based on head velocity and acceleration. Side information for P₁, P₂ and P₃ can be computed as per the above sections.

Systems and methods disclosed in the present disclosure may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly executes instructions to perform any one or more of the concepts discussed herein.

FIG. 9 shows a schematic block diagram of an example electronic device or

architecture 200 (e.g., an apparatus 200) suitable for implementing example embodiments of the present disclosure. Architecture 200 includes but is not limited to main processing devices and lightweight processing devices as described in relation to FIG. 3. As shown, the architecture 200 includes central processing unit (CPU) 201 which is capable of performing various processes in accordance with a program stored in, for example, read only memory (ROM) 202 or a program loaded from, for example, storage unit 208 to random access memory (RAM) 203. The CPU 201 may be, for example, an electronic processor 201, which may include one or more processor cores, and in some examples the processor 201 may be multiple processors. In RAM 203, the data required when CPU 201 performs the various processes is also stored, as required. CPU 201, ROM 202 and RAM 203 are connected to one another via bus 204. Input/output (I/O) interface 205 is also connected to bus 204.

The following components are connected to I/O interface 205: input unit 206, that may include a keyboard, a mouse, or the like; output unit 207 that may include a display such as a liquid crystal display (LCD) and one or more speakers; storage unit 208 including a hard disk, or another suitable storage device; and communication unit 209 which may include a network interface card such as a network card (e.g., wired or wireless).

In some implementations, input unit 206 includes one or more microphones in different positions (depending on the host device) enabling capture of audio signals in various formats (e.g., mono, stereo, spatial, immersive, and other suitable formats).

In some implementations, output unit 207 include systems with various number of speakers. Output unit 207 (depending on the capabilities of the host device) can render audio signals in various formats (e.g., mono, stereo, immersive, binaural, and other suitable formats).

In some embodiments, communication unit 209 is configured to communicate with other devices (e.g., via a network). Drive 210 is also connected to I/O interface 205, as required. Removable medium 211, such as a magnetic disk, an optical disk, a magneto-optical disk, a flash drive or another suitable removable medium is mounted on drive 210, so that a computer program read therefrom is installed into storage unit 208, as required. A person skilled in the art would understand that although apparatus 200 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 209, and/or installed from the removable medium 211, as shown in FIG. 9.

Generally, various example embodiments of the present disclosure may be implemented in hardware or special purpose circuits (e.g., control circuitry), software, logic or any combination thereof. For example, the various elements of FIG. 3 discussed above can be executed by control circuitry (e.g., CPU 201 in combination with other components of FIG. 9), thus, the control circuitry may be performing the actions described in this disclosure.

Some aspects may be implemented in hardware, while other aspects may be implemented in firmware or software which may be executed by a controller, a processor and/or other computing device(s), which may include control circuitry. While various aspects of the example embodiments of the present disclosure are illustrated and described as block diagrams, flowcharts, or using some other pictorial representation, it will be appreciated that the blocks, apparatus, systems, techniques, or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

Computer program code for carrying out methods of the present disclosure may be written in any combination of one or more programming languages. These computer program codes may be provided to one or more processors of a general-purpose computer, special purpose computer, or other programmable data processing apparatus that has control circuitry, such that the program codes, when executed by one or more processors of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as ROM, PROM, EPROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

The implementation of the technologies disclosed in the figures are merely illustrative examples, and the invention is not so limited. For example, the illustrated partitions such as blocks in FIG. 3 are merely illustrative logical partitions for ease of discussion, where such partitions may be split into additional partitions, combined into fewer partitions, supplemented with additional partitions, or reduced by eliminating partitions, without departing from the spirit of the present invention. For the illustrated flow charts of FIGS. 4-8, the partitions of the operational steps, which may be also referred to as functions, steps, operations, processes, or acts, may be combined into fewer steps or split into additional steps, where steps may be reordered or eliminated, in whole or in part, without departing from the spirit of this disclosure.

Unless specifically stated otherwise, as apparent from the following discussions, it is appreciated that throughout the disclosure discussions utilizing terms such as “processing”, “computing”, “calculating”, “determining”, “analyzing” or the like, may refer to the function, action, steps and/or processes of a computer hardware or computing system, or similar electronic computing devices, that manipulate and/or transform data represented as physical, such as electronic, quantities into other data similarly represented as physical quantities.

It should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some, but not other, features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the preferred embodiments described above. On the contrary, many modifications and variations are possible within the scope of the appended claims. For example, as mentioned above, the probing poses may be asymmetrically distributed around the reference pose. Also, the choice of actual pre-renditions and approximate representations may be different than those proposed above. Also, various additional techniques for encoding metadata, not disclosed herein, may be employed.

1. A method of rendering audio to enable split rendering with pose correction around multiple rotational axes, the method comprising:
obtaining an immersive audio content (A);
obtaining a reference pose (P′);
rendering the immersive audio content (A) into a first number of binaural pre-renditions (Binₙ), wherein the binaural pre-renditions (Binₙ) correspond to a set of probing poses (Pₙ) associated with the reference pose (P′), wherein the set of probing poses (Pₙ) include poses equal to the reference pose (P′) and/or poses that deviate from the reference pose (P′) by rotation about at least one of the rotational axes;
calculating a second number of approximate binaural representations (Bin′ₘ) based on the binaural pre-renditions (Binₙ), wherein the approximate binaural representations (Bin′ₘ) correspond to a set of virtual probing poses (Pₘ), wherein the virtual probing poses (Pₘ) deviate from the probing poses (Pₙ) by rotation around at least one of the rotational axes;
determining a reference binaural representation (Bin_{ref}) based on one or more of the binaural pre-renditions (Binₙ) and the approximate binaural representations (Bin′ₘ);
computing reconstruction metadata (M) to enable reconstruction of the binaural pre-renditions (Binₙ) and the approximate binaural representations (Bin′ₘ) from the reference binaural representation (Bin_{ref});
encoding the reconstruction metadata (M) and the reference binaural representation (Bin_{ref}) in an output bitstream (b₂); and
outputting the output bitstream (b₂).

2. The method according to claim 1, wherein the approximate binaural representations (Bin′ₘ) are calculated by interpolating the binaural pre-renditions (Binₙ).

3. The method according to claim 1, wherein at least one of the approximate binaural representations (Bin′ₘ) is computed by modifying the reconstruction metadata, and applying the modified reconstruction metadata to one of the binaural pre-renditions.

4. The method according to claim 1, wherein the reference binaural representation (Bin_{ref}) is selected from the binaural pre-renditions (Binₙ) and the approximate binaural representations (Bin′ₘ).

5. The method according to claim 1, wherein the reference binaural representation (Bin_{ref}) corresponds to the reference pose (P′) and is obtained by linearly combining the binaural pre-renditions.

6. The method according to claim 1, wherein the reference binaural representation (Bin_{ref}) corresponds to the reference pose (P′) and is obtained by binaural rendering of the immersive audio content (A).

7. The method according to claim 1, wherein the step of computing reconstruction metadata includes:
for each rotational axis:
selecting a first set of representations from the binaural pre-renditions (Binₙ) and the approximate binaural representations (Bin′ₘ), the first set of representations corresponding to probing poses deviating from each other by rotation around the rotational axis, and
computing axis-specific reconstruction metadata (M, H) which enables reconstruction of at least one representations in the set from another representation in the set, wherein the axis-specific reconstruction metadata (M, H) represents a deviation around the rotational axis.

8. The method according to claim 1, wherein at least one of the axis-specific reconstruction metadata (M, H) is computed before all approximate binaural representations (Bin′ₘ) are calculated, and wherein at least one of the approximate binaural representations (Bin′ₘ) is calculated by applying the axis-specific reconstruction metadata to one of the binaural pre-renditions.

9. The method according to claim 1, wherein the first number is D+1 and the second number is D−1, where D is the number of rotational axes.

10. The method according to claim 9, wherein D=2, and wherein:
a first probing pose (P₁) deviates from the reference pose (P′) by a first angle (−α) around a first axis and by a second angle (−β) around a second axis,
a second probing pose (P₂) deviates from the reference pose (P′) by the first angle (−α) around the first axis and by a third angle (+β) around the second axis,
a third probing pose (P₃) deviates from the reference pose (P′) by a fourth angle (+α) around the first axis and is equal to the reference pose (P′) around the second axis,
a first virtual probing pose (P₄) deviates from the reference pose (P′) by the first able (−α) around the first axis and is equal to the reference pose (P′) around the second axis.

11. The method according to claim 10, wherein the fourth value (+α) is the negative of the first value (−α), and wherein the third value (+β) is the negative of the second value (−β).

12. The method according to claim 9, wherein D=3, and wherein:
a first probing pose (P₁) deviates from the reference pose (P′) by a first angle (−α) around a first axis, by a second angle (−β) around a second axis, and by a third angle (−γ) around a third axis,
a second probing pose (P₂) deviates from the reference pose (P′) by the first angle (−α) around the first axis, by the second angle (−β) around the second axis, and by a fourth angle (+γ) around the third axis,
a third probing pose (P₃) deviates from the reference pose (P′) by the first angle (−α) around the first axis, by a fifth angle (+β) around the second axis, and is equal to the reference pose (P′) around the third axis,
a fourth probing pose (P₄) deviates from the reference pose (P′) by the sixth angle (+α) around the first axis, and is equal to the reference pose (P′) around the second and third degrees of freedom,
a first virtual probing pose (P₅) deviates from the reference pose (P′) by the first angle (−α) around the first axis, by the second angle (−β) around the second axis, and is equal to the reference pose (P′) around the third axis, and
a second virtual probing pose (P₆) deviates from the reference pose (P′) by the first angle (−α) around the first axis, and is equal to the reference pose (P′) around the second and third degrees of freedom.

13. The method according to claim 12, wherein the sixth angle (+α) is the negative of the first angle (−α), wherein the fifth angle (+β) is the negative of the second angle (−β), and wherein the fourth angle (+γ) is the negative of the third angle (−γ).

14. The method according to claim 10, wherein the first axis is the yaw axis, the second axis is the pitch axis and the third axis is the roll axis.

15. The method according to claim 1, wherein the reference pose (P′) is based on user head pose information obtained from a user-held device.

16. The method according to claim 15, wherein pose information indicative of the reference pose (P′) is encoded and included in the output bitstream (b₂).

17. The method according to claim 1, wherein pose information indicative of the probing poses (Pₙ) and virtual probing poses (Pₘ) is encoded and included in the output bitstream (b₂).

18. The method according to claim 1, wherein the reconstruction metadata (M) includes, for each time-frequency tile, a two-by-two matrix.

19. The method according to claim 18, further comprising quantizing and encoding the reconstruction metadata (M) based on symmetries in reconstruction metadata.

20. The method according to claim 18, further comprising encoding the reconstruction metadata (M) using differential coding between metadata relating to different probing poses.

21. An apparatus comprising a processor and a memory coupled to the processor, wherein the processor is adapted to cause the apparatus to carry out the method according to claim 1.

22. A computer-readable storage medium storing a program comprising instructions that, when executed by a processor, cause the processor to carry out the method according to claim 1.

23-80. (canceled)
